(19) United States
(12) Patent Application Publication
(10) Pub. No.: US 2026/0283119 A1
(43) Pub. Date: Sep. 24, 2026

(54) SYSTEM FOR PREDICTING BEHAVIOR OF A SCHOOL OF FISH

(71) Applicant: SoftBank Group Corp., Tokyo (JP)

(72) Inventor: Noritomo ENDO, Tokyo (JP)

(21) Appl. No.: 19/567,255

(22) Filed: Mar. 16, 2026

Related U.S. Application Data
(60) Provisional application No. 63/775,297, filed on Mar. 21, 2025.

(51) Int. Cl. A01K 29/00; G01W 1/02; G01W 1/10

(52) U.S. Cl. CPC A01K 29/005; G01W 1/02; G01W 1/10; G01W 2201/00

(57) ABSTRACT

A system for the purpose of improving a fish catch in a fishery includes a marine data collection unit, a fish species behavior prediction unit, a display control unit, a database management unit, and a user interface unit. The marine data collection unit collects data such as nautical charts, GPS, air temperature, seawater temperature, wind speed, tidal currents, moon age, tide graphs, fish catches, fishing locations, ecology of fish and shellfish, salinity, and rate of change in air temperature due to global warming. The fish species behavior prediction unit predicts the behavior of fish schools using a machine learning algorithm based on these data. The display control unit displays the prediction results in real time on a nautical chart or GPS, and provides a guideline for fishermen to select an optimal fishing ground.

### CROSS-REFERENCE TO RELATED APPLICATIONS

This application is based upon and claims the benefit of priority from U.S. Provisional Patent Application No. 63/775297, filed on Mar. 21, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is uncertainty of fish catches and a decrease in efficiency in the fishery industry. In conventional fishing activities, it has been difficult to accurately grasp the location and movement patterns of fish schools, and fishermen have often selected fishing grounds by relying on experience and intuition. For this reason, the fish catch could not be predicted, and efficient fishing activities were difficult. In addition, there was a lack of means to appropriately evaluate the effects of environmental changes and fluctuations in weather conditions on the behavior of fish schools, and it was a difficult situation to realize sustainable fishery.

Disclosed herein is to accurately grasp the position of fish schools and select optimal fishing grounds by integrally analyzing a plurality of data sources and predicting the behavior of fish species. This is expected to improve the efficiency of fishery and increase the fish catch. In addition, it enables flexible responses to environmental changes and can contribute to the realization of sustainable fishery. Furthermore, fishermen can improve profitability while minimizing the burden on the environment. In this way, efficient and sustainable fishing activities are realized by reducing uncertainty in the fishery industry.

Disclosed herein is a system including a marine data collection unit, a fish species behavior prediction unit, and a display control unit. The marine data collection unit has a function of acquiring information from a plurality of data sources including nautical chart data, GPS data, air temperature data, seawater temperature data, wind speed data, tidal current data, moon age data, tide graph data, fish catch data, fishing location data, ecological data of fish and shellfish, salinity data, and data on a rate of change in air temperature due to global warming. This makes it possible to comprehensively grasp various environmental conditions related to the fishery industry.

The fish species behavior prediction unit has a function of predicting a behavior pattern of a target fish species using a machine learning algorithm or a statistical model based on the collected data. For example, it compares past data with current environmental conditions and estimates a movement route of a school of fish in a specific time period. This prediction allows fishermen to grasp the trend of fish schools in advance and enables efficient selection of fishing grounds.

The display control unit has a function of displaying predicted position information and a movement route of a school of fish on a nautical chart of a fish finder and on a GPS in real time. This display allows fishermen to accurately grasp the position of the school of fish and obtain a guideline for selecting an optimal fishing ground. This is expected to improve the efficiency of fishery and increase the fish catch, and can also contribute to the realization of sustainable fishery.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of predicting behavior of a school of fish.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### FIRST EMBODIMENT

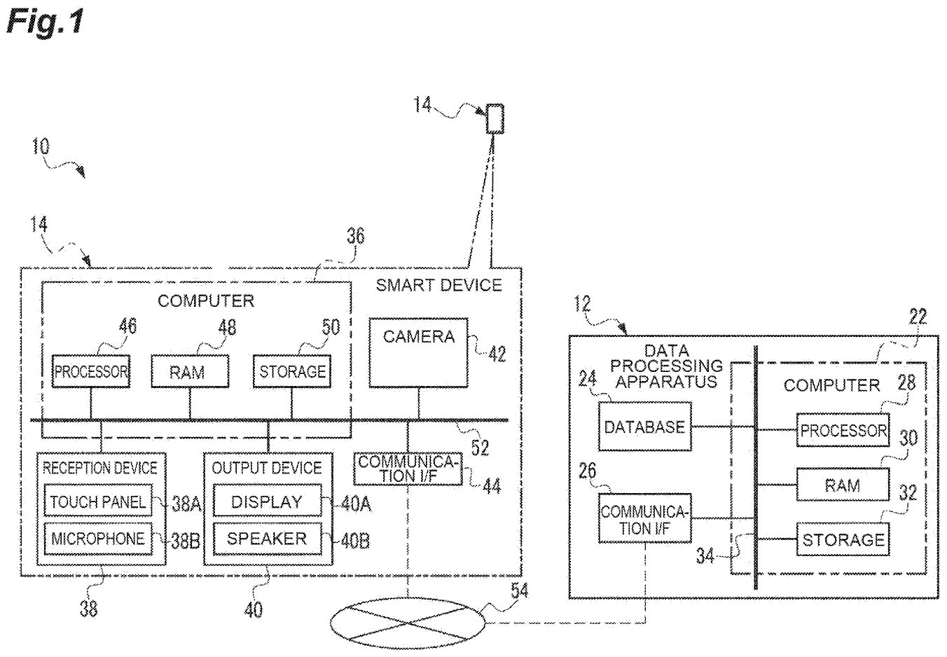

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

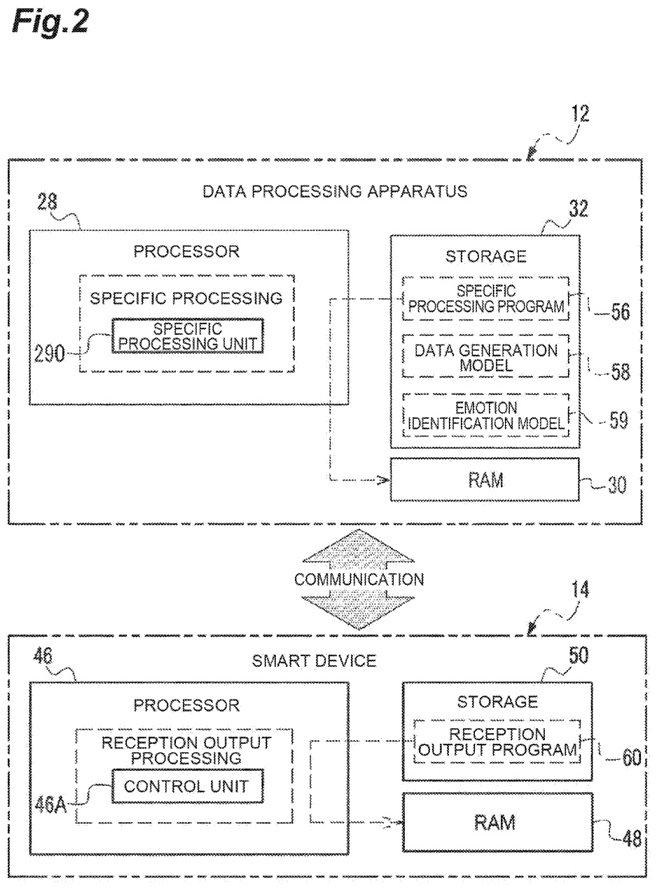

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

The system is configured with two main components: a server and a terminal. The server mainly assumes the role of data collection, analysis, and prediction, and the terminal functions as an information provider and an interface for fishermen.

First, on the server side, a marine data collection unit is implemented. This unit acquires information from various data sources including nautical chart data, GPS data, air temperature data, seawater temperature data, wind speed data, tidal current data, moon age data, tide graph data, fish catch data, fishing location data, ecological data of fish and shellfish, salinity data, and data on a rate of change in air temperature due to global warming. For example, it periodically collects data from weather observation stations and ocean observation buoys via the Internet and accumulates it in a database. This database is organized for each type of data, enabling quick access and analysis. In addition, it also collects past fishing records and ecological data of fish and shellfish provided by academic research institutions, and integrally manages them. This makes it possible to comprehensively grasp various environmental conditions related to the fishery industry.

The marine data collection unit may be configured by, for example, the computer 22 (the processor 28 and the like), the database 24, and the communication I/F 26 of the data processing apparatus 12, or may be configured by the specific processing unit 290, the specific processing program 56, the data generation model 58, and the like.

Next, a fish species behavior prediction unit on the server predicts behavior patterns of fish species using a machine learning algorithm or a statistical model based on the collected data. In this unit, for example, it simulates how a specific fish species moves by combining past tidal current data and current water temperature data. For example, it analyzes the influence of the strength and direction of tidal currents and changes in water temperature on the movement of fish with a numerical model, and estimates in which area a school of fish is highly likely to gather. In addition, it evaluates the influence of the ebb and flow of the tide on the movement of fish schools using moon age and tide graph data, and predicts the appearance pattern of fish schools. Furthermore, the machine learning algorithm learns from past fish catch data and improves its ability to predict the behavior of fish species under specific environmental conditions.

The prediction processing in the fish species behavior prediction unit is not limited to mere statistical processing, but can be executed using a neural network (for example, LSTM: Long Short-Term Memory or CNN: Convolutional Neural Network) that takes multidimensional environmental data as input. For example, the processor may input seawater temperature data and tidal current data, which are time-series data, into an LSTM layer to extract temporal fluctuation features, and at the same time, input spatial positional relationships obtained from nautical chart data and GPS data into a CNN layer to extract spatial features. The fish species behavior prediction unit may generate a heat map indicating a probability that a specific fish species exists by integrating these temporal features and spatial features in a concatenation layer. This processing identifies non-linear correlations among a vast number of data points (for example, millions of grid data) far exceeding a range calculable by a human in a human mind, and is achieved for the first time by utilizing computing power of a computer.

The fish species behavior prediction unit may be configured by, for example, the computer 22 (the processor 28 and the like) of the data processing apparatus 12, or may be configured by the specific processing unit 290, the specific processing program 56, the data generation model 58, and the like.

The system may include an automatic navigation control unit that transmits a control signal to a steering system (autopilot) of a vessel based on a predicted movement route of the school of fish. The automatic navigation control unit may compare a predicted movement speed of the school of fish with a current speed of the vessel and tidal current data, and calculate an optimal route and a recommended speed at which a probability of encountering the school of fish is highest. The calculated data is directly transmitted to a steering device via an inboard network such as a CAN (Controller Area Network), and can physically change a course of the vessel. This makes it possible to reach a fishing ground in the shortest time while minimizing fuel consumption (energy saving effect) compared to a case of relying on a fisherman's intuition, thereby realizing a technical improvement in operation efficiency of the vessel.

On the terminal side, a display control unit is implemented. This unit receives the prediction result transmitted from the server and displays it on a nautical chart of a fish finder and on a GPS in real time. For example, it visually displays the estimated position and movement route of a school of fish on a mobile terminal or a dedicated display device used by a fisherman on a boat. The display is represented as icons indicating the position of the school of fish or color-coded areas on a map, and is designed to be intuitively understood by the fisherman. In addition, the type and number of predicted fish species are also displayed, providing a guideline for the fisherman to perform fishing efficiently. Furthermore, the terminal allows the fisherman to perform filtering and customization based on specific conditions via a user interface. For example, it includes a setting to display only a specific fish species and a function to highlight prediction information in a specific time period.

The display control unit may dynamically change a display mode in accordance with a confidence score of prediction data on a display device such as a GPS plotter. For example, the display control unit may highlight an area where prediction reliability exceeds a predetermined threshold (for example, 80%) with high brightness or red color, and display an area where the prediction reliability is less than the threshold with increased transparency. At this time, the processor may monitor a drawing load (GPU resource) of the display device and perform rendering optimization processing to omit or simplify polygon drawing of an area with low reliability. This makes it possible to perform real-time display without delay within limited hardware resources on a boat even when handling a vast amount of marine data.

The display control unit may be configured by, for example, the computer 36 (the processor 46 and the like), the output device 40 (the display 40A, the speaker 40B, and the like), and the communication I/F 44 of the smart device 14.

In this way, by the server and the terminal cooperating, fishermen can formulate a strategy to select the optimal fishing ground and maximize the fish catch based on information updated in real time. Furthermore, the system enables a flexible response to environmental changes and is expected to contribute to the realization of sustainable fishery. The introduction of this system is expected to improve the efficiency of fishery and increase the fish catch, and also makes it possible to improve profitability while minimizing the burden on the environment.

### (System Configuration)

The system includes a marine data collection unit, a fish species behavior prediction unit, a display control unit, a database management unit, and a user interface unit. The marine data collection unit acquires information from various data sources including nautical chart data, GPS data, air temperature data, seawater temperature data, wind speed data, tidal current data, moon age data, tide graph data, fish catch data, fishing location data, ecological data of fish and shellfish, salinity data, and data on a rate of change in air temperature due to global warming. For example, it periodically collects data from weather observation stations and ocean observation buoys via the Internet and accumulates it in a database. This database is organized for each type of data, enabling quick access and analysis. In addition, it also collects past fishing records and ecological data of fish and shellfish provided by academic research institutions, and integrally manages them. Furthermore, the marine data collection unit can update data in real time and can always reflect the latest environmental information.

The fish species behavior prediction unit predicts behavior patterns of fish species using a machine learning algorithm or a statistical model based on the collected data. This unit simulates how a specific fish species moves by combining past tidal current data and current water temperature data. For example, it analyzes the influence of the strength and direction of tidal currents and changes in water temperature on the movement of fish with a numerical model, and estimates in which area a school of fish is highly likely to gather. In addition, it evaluates the influence of the ebb and flow of the tide on the movement of fish schools using moon age and tide graph data, and predicts the appearance pattern of fish schools. Furthermore, the machine learning algorithm learns from past fish catch data and improves its ability to predict the behavior of fish species under specific environmental conditions. This allows fishermen to grasp the trend of fish schools in advance and enables efficient selection of fishing grounds.

The display control unit receives the prediction result transmitted from the server and displays it on a nautical chart of a fish finder and on a GPS in real time. For example, it visually displays the estimated position and movement route of a school of fish on a mobile terminal or a dedicated display device used by a fisherman on a boat. The display is represented as icons indicating the position of the school of fish or color-coded areas on a map, and is designed to be intuitively understood by the fisherman. In addition, the type and number of predicted fish species are also displayed, providing a guideline for the fisherman to perform fishing efficiently. Furthermore, the display control unit updates the prediction information in real time, allowing the fisherman to always make decisions based on the latest information.

The database management unit organizes, stores, and retrieves the collected data. This unit classifies the data according to the type and collection source of the data, and enables efficient data access. For example, air temperature data and seawater temperature data are organized along a time axis, making it easy to compare with past data. In addition, fish catch data and fishing location data are linked with a geographic information system, enabling visual analysis on a map. Furthermore, the database management unit is provided with data backup and recovery functions, and ensures the safety and reliability of the data.

The user interface unit provides an interface for fishermen to operate the system. This unit adopts an intuitive and easy-to-use design, and allows fishermen to quickly access necessary information. For example, it includes a setting to display only a specific fish species and a function to highlight prediction information in a specific time period. In addition, the user interface unit can receive feedback from fishermen and use it to improve the system. Furthermore, it supports various operation methods such as voice input and gesture operation, and improves the convenience for fishermen.

Specific examples of prompt sentences to be read into a generative AI include “Please explain in detail the types of data collected by the marine data collection unit and their acquisition methods,” “Please specifically indicate the types of algorithms used by the fish species behavior prediction unit and their application methods,” and “Please explain in detail the types of information provided by the display control unit and their display methods.” These prompt sentences can be used to understand in detail how each unit of the system functions and to help in embodying the system.

### (Implementation Steps)

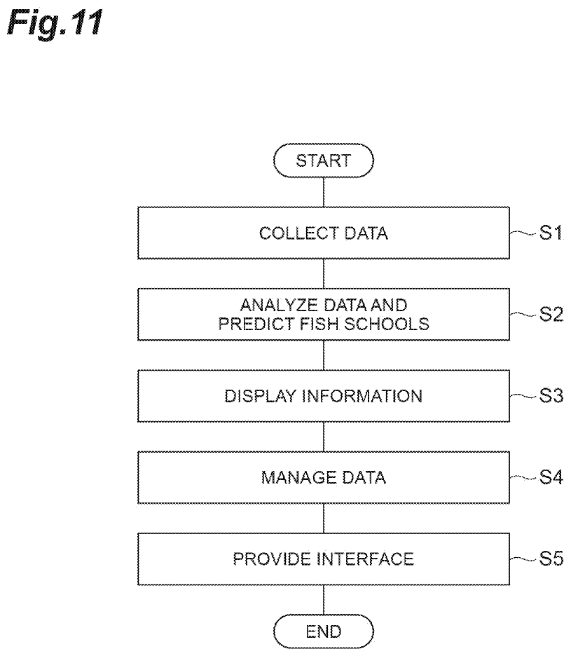

### Step 1: Data Collection (Refer to Step S1 of FIG. 11)

The marine data collection unit acquires information from various data sources including nautical chart data, GPS data, air temperature data, seawater temperature data, wind speed data, tidal current data, moon age data, tide graph data, fish catch data, fishing location data, ecological data of fish and shellfish, salinity data, and data on a rate of change in air temperature due to global warming. For example, it periodically collects data from weather observation stations and ocean observation buoys via the Internet and accumulates it in a database. This database is organized for each type of data, enabling quick access and analysis. In addition, it also collects past fishing records and ecological data of fish and shellfish provided by academic research institutions, and integrally manages them. Furthermore, the marine data collection unit can update data in real time and can always reflect the latest environmental information.

### Step 2: Data Analysis and Prediction (Refer to Step S2 of FIG. 11)

The fish species behavior prediction unit predicts behavior patterns of fish species using a machine learning algorithm or a statistical model based on the collected data. This unit simulates how a specific fish species moves by combining past tidal current data and current water temperature data. For example, it analyzes the influence of the strength and direction of tidal currents and changes in water temperature on the movement of fish with a numerical model, and estimates in which area a school of fish is highly likely to gather. In addition, it evaluates the influence of the ebb and flow of the tide on the movement of fish schools using moon age and tide graph data, and predicts the appearance pattern of fish schools. A specific example of a prompt sentence to be read into a generative AI is “Please specifically indicate the types of algorithms used by the fish species behavior prediction unit and their application methods.”

### Step 3: Information Display (Refer to Step S3 of FIG. 11)

The display control unit receives the prediction result transmitted from the server and displays it on a nautical chart of a fish finder and on a GPS in real time. For example, it visually displays the estimated position and movement route of a school of fish on a mobile terminal or a dedicated display device used by a fisherman on a boat. The display is represented as icons indicating the position of the school of fish or color-coded areas on a map, and is designed to be intuitively understood by the fisherman. In addition, the type and number of predicted fish species are also displayed, providing a guideline for the fisherman to perform fishing efficiently. Furthermore, the display control unit updates the prediction information in real time, allowing the fisherman to always make decisions based on the latest information.

### Step 4: Data Management (Refer to Step S4 of FIG. 11)

The database management unit organizes, stores, and retrieves the collected data. This unit classifies the data according to the type and collection source of the data, and enables efficient data access. For example, air temperature data and seawater temperature data are organized along a time axis, making it easy to compare with past data. In addition, fish catch data and fishing location data are linked with a geographic information system, enabling visual analysis on a map. Furthermore, the database management unit is provided with data backup and recovery functions, and ensures the safety and reliability of the data.

### Step 5: User Interface (Refer to Step S5 of FIG. 11)

The user interface unit provides an interface for fishermen to operate the system. This unit adopts an intuitive and easy-to-use design, and allows fishermen to quickly access necessary information. For example, it includes a setting to display only a specific fish species and a function to highlight prediction information in a specific time period. In addition, the user interface unit can receive feedback from fishermen and use it to improve the system. Furthermore, it supports various operation methods such as voice input and gesture operation, and improves the convenience for fishermen. A specific example of a prompt sentence to be read into a generative AI is “Please explain in detail the functions provided by the user interface unit and their operation methods.”

### (Specific Use Case)

For example, a case is considered where a fisherman uses the system to maximize the fish catch in a coastal area. The fisherman first acquires nautical chart data, GPS data, air temperature data, seawater temperature data, wind speed data, tidal current data, moon age data, and tide graph data of the target sea area through the marine data collection unit. These data are collected in real time from weather observation stations and ocean observation buoys via the Internet and accumulated in a database. The fisherman also refers to past fish catch data and fishing location data to grasp the appearance pattern of fish schools.

Next, the fish species behavior prediction unit predicts behavior patterns of fish species using a machine learning algorithm based on the collected data. For example, it analyzes the influence of the strength and direction of tidal currents and changes in water temperature on the movement of fish, and estimates in which area a school of fish is highly likely to gather. This prediction allows the fisherman to grasp the trend of fish schools in advance and enables efficient selection of fishing grounds.

The display control unit displays the prediction result on a nautical chart of a fish finder and on a GPS in real time. The fisherman can visually confirm the estimated position and movement route of a school of fish on a mobile terminal or a dedicated display device used on a boat. The display is represented as icons indicating the position of the school of fish or color-coded areas on a map, and is designed to be intuitively understood by the fisherman. The type and number of predicted fish species are also displayed, providing a guideline for the fisherman to perform fishing efficiently.

The database management unit organizes, stores, and retrieves the collected data, and enables efficient data access. Air temperature data and seawater temperature data are organized along a time axis, making it easy to compare with past data. Fish catch data and fishing location data are linked with a geographic information system, enabling visual analysis on a map.

The user interface unit provides an interface for fishermen to operate the system and adopts an intuitive and easy-to-use design. The fisherman can use a setting to display only a specific fish species and a function to highlight prediction information in a specific time period. It supports various operation methods such as voice input and gesture operation, and improves the convenience for fishermen.

Specific examples of prompt sentences to be read into a generative AI include “Please explain in detail the types of data collected by the marine data collection unit and their acquisition methods,” “Please specifically indicate the types of algorithms used by the fish species behavior prediction unit and their application methods,” “Please explain in detail the types of information provided by the display control unit and their display methods,” and “Please explain in detail the functions provided by the user interface unit and their operation methods.” These prompt sentences can be used to understand in detail how each unit of the system functions and to help in embodying the system.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

The system aims to improve the efficiency of an entire city and the quality of life of residents, and includes an urban data collection unit, an energy consumption prediction unit, a traffic flow control unit, an environment monitoring unit, and a resident interface unit.

The urban data collection unit acquires information from various sensors and data sources installed in the city. For example, it acquires power consumption data from electric power companies and grasps in detail the consumption patterns of each household and building. This makes it possible to analyze consumption trends for each time period and predict power demand during peak hours. From a traffic management system, it acquires traffic flow data of major roads and intersections and monitors the traffic volume in real time. For example, it collects data on the inflow and outflow of vehicles at a specific intersection and utilizes it as data for preventing the occurrence of traffic congestion. From weather observation stations, it collects weather data such as air temperature, humidity, wind speed, and precipitation, and grasps changes in the urban environment. This makes it possible to evaluate the influence of weather conditions on energy consumption and traffic flow. From environmental sensors, it acquires data on air quality and noise levels and monitors the health of the urban environment. For example, it measures the concentration of PM2.5 and nitrogen dioxide, and if a deterioration in air quality is detected, it issues a warning to residents. Furthermore, from residents' smartphones and wearable devices, it collects movement pattern data and analyzes the behavioral trends of residents. This makes it possible to grasp the usage status of public transportation and the flow of pedestrians, and to help improve urban planning.

The energy consumption prediction unit predicts the energy consumption of the entire city based on the collected data. It uses a machine learning algorithm to analyze past consumption patterns and current data, and predicts energy consumption during peak hours. For example, it predicts fluctuations in energy consumption under specific seasons and weather conditions, and proposes peak shifting and energy-saving measures to electric power companies. In addition, based on the prediction result of energy consumption, it provides specific power-saving advice to each household and building, and aims to improve energy efficiency.

The traffic flow control unit analyzes traffic flow data and alleviates congestion through signal control and traffic guidance. For example, at an intersection with a large traffic volume, it adjusts the timing of signals in real time to smooth the flow of traffic. In addition, it provides residents with optimal routes and performs navigation to avoid traffic congestion. This is expected to shorten commuting times and reduce traffic accidents. Furthermore, it monitors the operation status of public transportation, and if a delay occurs, it proposes an alternative route, thereby smoothing the movement of residents.

The traffic flow control unit may adopt edge computing technology and perform distributed processing in a traffic light control unit (edge node) installed at each intersection. When all traffic data is processed by a central server, there is a risk that a response to a sudden accident or sudden traffic congestion is delayed due to communication delay (latency). Each edge node locally predicts a traffic flow several seconds later based on immediate camera images and vehicle sensor data, and autonomously finely adjusts switching timing of a traffic light without waiting for an instruction from the central server. With this distributed processing architecture, traffic control that ensures real-time performance is realized while suppressing consumption of network bandwidth.

The environment monitoring unit monitors air quality and noise levels based on environmental sensor data. For example, if the air quality deteriorates, it sends a notification to residents to refrain from going out. In addition, in areas with high noise levels, it proposes soundproofing measures. This makes it possible to maintain the health and comfortable living environment of residents. Furthermore, based on environmental data, it proposes urban greening plans and environmental improvement measures, and supports the realization of a sustainable urban environment.

The resident interface unit provides residents with information on energy consumption status, traffic information, and environmental information. Through a smartphone application or a web portal, residents can check information in real time and take actions to improve their quality of life. For example, by checking the energy consumption status and saving power, they can reduce their electricity bills. In addition, based on traffic information, they can select the optimal commuting route. Furthermore, it can receive feedback from residents and use it to improve the system.

Specific examples of prompt sentences to be read into a generative AI include “Please explain in detail the types of data collected by the urban data collection unit and their acquisition methods,” “Please specifically indicate the types of algorithms used by the energy consumption prediction unit and their application methods,” “Please explain in detail the functions provided by the traffic flow control unit and their implementation methods,” “Please explain in detail the types of information provided by the environment monitoring unit and their monitoring methods,” and “Please explain in detail the functions provided by the resident interface unit and their operation methods.” These prompt sentences can be used to understand in detail how each unit of the system functions and to help in embodying the system.

### (System Configuration)

The system includes an urban data collection unit, an energy consumption prediction unit, a traffic flow control unit, an environment monitoring unit, and a resident interface unit. The urban data collection unit has a function of acquiring information from various sensors and data sources installed in the city. This unit acquires power consumption data from electric power companies and grasps in detail the consumption patterns of each household and building. For example, it is possible to analyze consumption trends for each time period and predict power demand during peak hours. In addition, from a traffic management system, it acquires traffic flow data of major roads and intersections and monitors the traffic volume in real time. For example, it collects data on the inflow and outflow of vehicles at a specific intersection and utilizes it as data for preventing the occurrence of traffic congestion. Furthermore, from weather observation stations, it collects weather data such as air temperature, humidity, wind speed, and precipitation, and grasps changes in the urban environment. This makes it possible to evaluate the influence of weather conditions on energy consumption and traffic flow. From environmental sensors, it acquires data on air quality and noise levels and monitors the health of the urban environment. For example, it measures the concentration of PM2.5 and nitrogen dioxide, and if a deterioration in air quality is detected, it issues a warning to residents. Furthermore, from residents'smartphones and wearable devices, it collects movement pattern data and analyzes the behavioral trends of residents. This makes it possible to grasp the usage status of public transportation and the flow of pedestrians, and to help improve urban planning.

The energy consumption prediction unit has a function of predicting the energy consumption of the entire city based on the collected data. This unit uses a machine learning algorithm to analyze past consumption patterns and current data, and predicts energy consumption during peak hours. For example, it predicts fluctuations in energy consumption under specific seasons and weather conditions, and proposes peak shifting and energy-saving measures to electric power companies. In addition, based on the prediction result of energy consumption, it provides specific power-saving advice to each household and building, and aims to improve energy efficiency. Furthermore, by optimizing energy consumption, the sustainability of the entire city can be enhanced.

The traffic flow control unit has a function of analyzing traffic flow data and alleviating congestion through signal control and traffic guidance. This unit adjusts the timing of signals in real time at an intersection with a large traffic volume to smooth the flow of traffic. For example, during a time period when traffic congestion is likely to occur, it improves the flow of vehicles by extending the green light time of the signal. In addition, it provides residents with optimal routes and performs navigation to avoid traffic congestion. This is expected to shorten commuting times and reduce traffic accidents. Furthermore, it monitors the operation status of public transportation, and if a delay occurs, it proposes an alternative route, thereby smoothing the movement of residents.

The environment monitoring unit has a function of monitoring air quality and noise levels based on environmental sensor data. This unit sends a notification to residents to refrain from going out if the air quality deteriorates. For example, if the concentration of PM2.5 exceeds a reference value, it issues an alert and protects the health of residents. In addition, in areas with high noise levels, it proposes soundproofing measures. This makes it possible to maintain the health and comfortable living environment of residents. Furthermore, based on environmental data, it proposes urban greening plans and environmental improvement measures, and supports the realization of a sustainable urban environment.

The resident interface unit has a function of providing residents with information on energy consumption status, traffic information, and environmental information. This unit allows residents to check information in real time and take actions to improve their quality of life through a smartphone application or a web portal. For example, by checking the energy consumption status and saving power, they can reduce their electricity bills. In addition, based on traffic information, they can select the optimal commuting route. Furthermore, it can receive feedback from residents and use it to improve the system.

Specific examples of prompt sentences to be read into a generative AI include “Please explain in detail the types of data collected by the urban data collection unit and their acquisition methods,” “Please specifically indicate the types of algorithms used by the energy consumption prediction unit and their application methods,” “Please explain in detail the functions provided by the traffic flow control unit and their implementation methods,” “Please explain in detail the types of information provided by the environment monitoring unit and their monitoring methods,” and “Please explain in detail the functions provided by the resident interface unit and their operation methods.” These prompt sentences can be used to understand in detail how each unit of the system functions and to help in embodying the system.

### (Implementation Steps)

### Step 1: Data Collection

The urban data collection unit acquires information from various sensors and data sources installed in the city. For example, it acquires power consumption data from electric power companies and grasps in detail the consumption patterns of each household and building. From a traffic management system, it acquires traffic flow data of major roads and intersections and monitors the traffic volume in real time. From weather observation stations, it collects weather data such as air temperature, humidity, wind speed, and precipitation, and grasps changes in the environment. From environmental sensors, it acquires data on air quality and noise levels and monitors the health of the urban environment. From residents'smartphones and wearable devices, it collects movement pattern data and analyzes the behavioral trends of residents. These data are accumulated in a database in real time, making it possible to comprehensively grasp the situation of the entire city.

### Step 2: Energy Consumption Prediction

The energy consumption prediction unit predicts the energy consumption of the entire city based on the collected data. It uses a machine learning algorithm to analyze past consumption patterns and current data, and predicts energy consumption during peak hours. For example, it predicts fluctuations in energy consumption under specific seasons and weather conditions, and proposes peak shifting and energy-saving measures to electric power companies. A specific example of a prompt sentence to be read into a generative AI is “Please specifically indicate the types of algorithms used by the energy consumption prediction unit and their application methods.”

### Step 3: Traffic Flow Control

The traffic flow control unit analyzes traffic flow data and alleviates congestion through signal control and traffic guidance. At an intersection with a large traffic volume, it adjusts the timing of signals in real time to smooth the flow of traffic. It provides residents with optimal routes and performs navigation to avoid traffic congestion. This is expected to shorten commuting times and reduce traffic accidents.

### Step 4: Environment Monitoring

The environment monitoring unit monitors air quality and noise levels based on environmental sensor data. If the air quality deteriorates, it sends a notification to residents to refrain from going out. In areas with high noise levels, it proposes soundproofing measures. This makes it possible to maintain the health and comfortable living environment of residents.

### Step 5: Resident Interface

The resident interface unit provides residents with information on energy consumption status, traffic information, and environmental information. Through a smartphone application or a web portal, residents can check information in real time and take actions to improve their quality of life. For example, by checking the energy consumption status and saving power, they can reduce their electricity bills.

### (Specific Use Case)

For example, a case is considered where the system is used to improve the energy efficiency of a city. The urban data collection unit acquires power consumption data from electric power companies and grasps in detail the consumption patterns of each household and building. This makes it possible to analyze consumption trends for each time period and predict power demand during peak hours. From a traffic management system, it acquires traffic flow data of major roads and intersections and monitors the traffic volume in real time. This makes it possible to utilize the data as data for preventing the occurrence of traffic congestion. From weather observation stations, it collects weather data such as air temperature, humidity, wind speed, and precipitation, and grasps changes in the urban environment. This makes it possible to evaluate the influence of weather conditions on energy consumption and traffic flow. From environmental sensors, it acquires data on air quality and noise levels and monitors the health of the urban environment. This makes it possible to issue a warning to residents if a deterioration in air quality is detected. From residents' smartphones and wearable devices, it collects movement pattern data and analyzes the behavioral trends of residents. This makes it possible to grasp the usage status of public transportation and the flow of pedestrians, and to help improve urban planning.

The energy consumption prediction unit predicts the energy consumption of the entire city based on the collected data. It uses a machine learning algorithm to analyze past consumption patterns and current data, and predicts energy consumption during peak hours. This makes it possible to predict fluctuations in energy consumption under specific seasons and weather conditions, and to propose peak shifting and energy-saving measures to electric power companies. The traffic flow control unit analyzes traffic flow data and alleviates congestion through signal control and traffic guidance. This makes it possible to adjust the timing of signals in real time at an intersection with a large traffic volume to smooth the flow of traffic. It can provide residents with optimal routes and perform navigation to avoid traffic congestion.

The environment monitoring unit monitors air quality and noise levels based on environmental sensor data. This makes it possible to send a notification to residents to refrain from going out if the air quality deteriorates. It can propose soundproofing measures in areas with high noise levels. The resident interface unit provides residents with information on energy consumption status, traffic information, and environmental information. Through a smartphone application or a web portal, residents can check information in real time and take actions to improve their quality of life. For example, by checking the energy consumption status and saving power, they can reduce their electricity bills.

Specific examples of prompt sentences to be read into a generative AI include “Please explain in detail the types of data collected by the urban data collection unit and their acquisition methods,” “Please specifically indicate the types of algorithms used by the energy consumption prediction unit and their application methods,” “Please explain in detail the functions provided by the traffic flow control unit and their implementation methods,” “Please explain in detail the types of information provided by the environment monitoring unit and their monitoring methods,” and “Please explain in detail the functions provided by the resident interface unit and their operation methods.” These prompt sentences can be used to understand in detail how each unit of the system functions and to help in embodying the system.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than the generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### SECOND EMBODIMENT

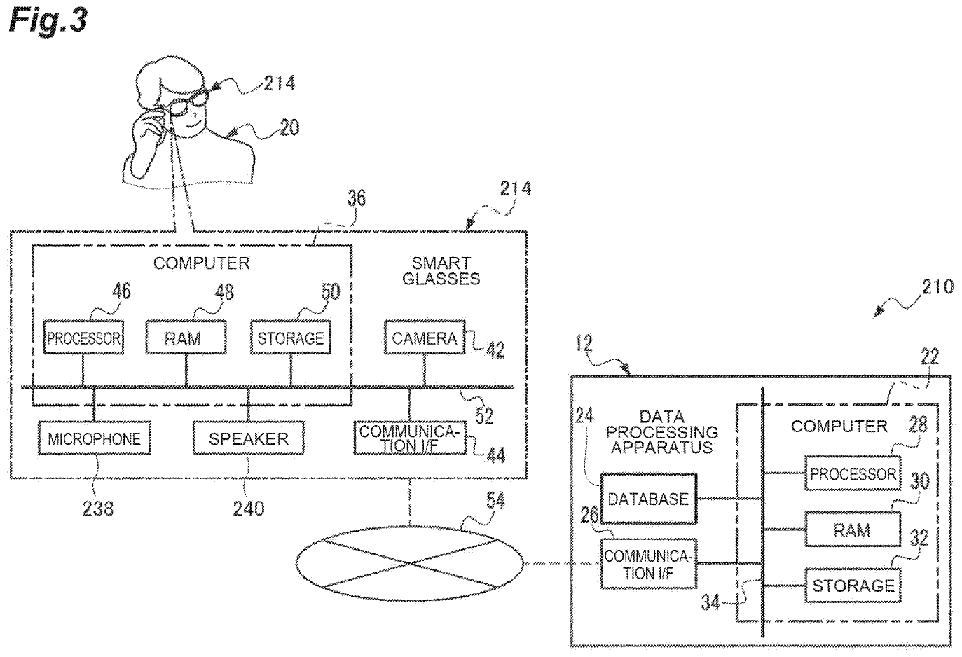

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

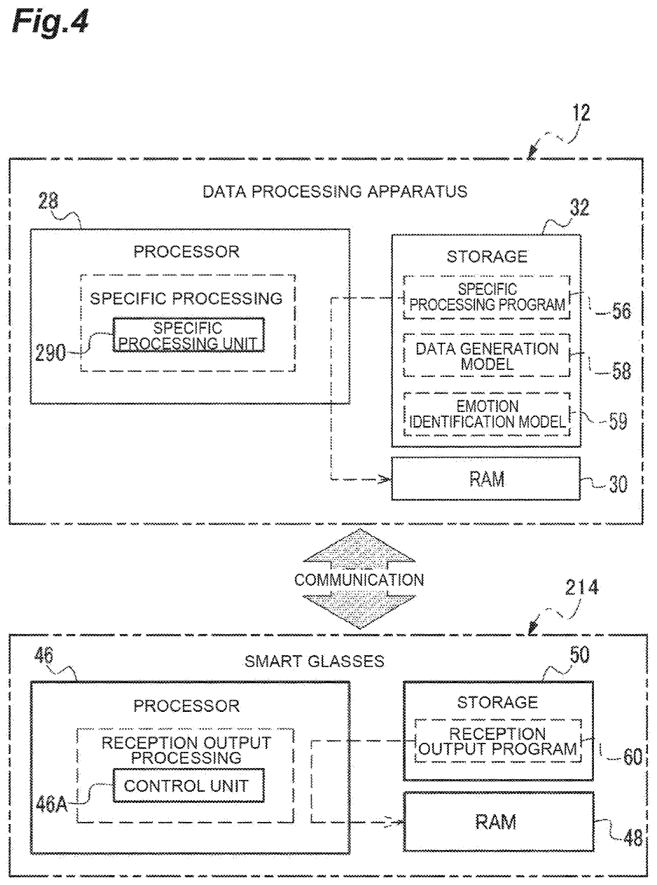

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than the generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### THIRD EMBODIMENT

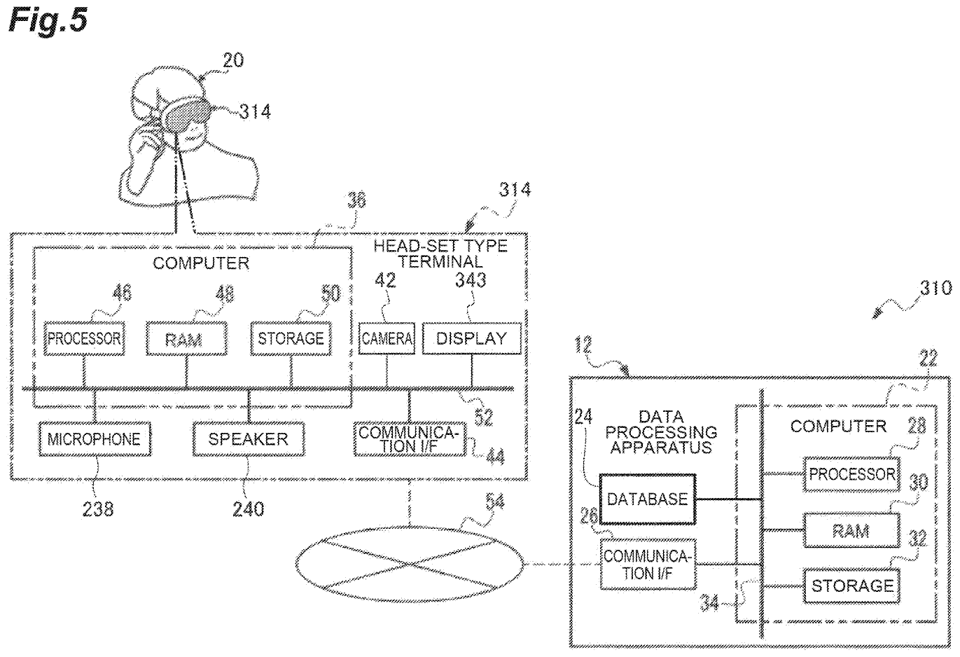

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

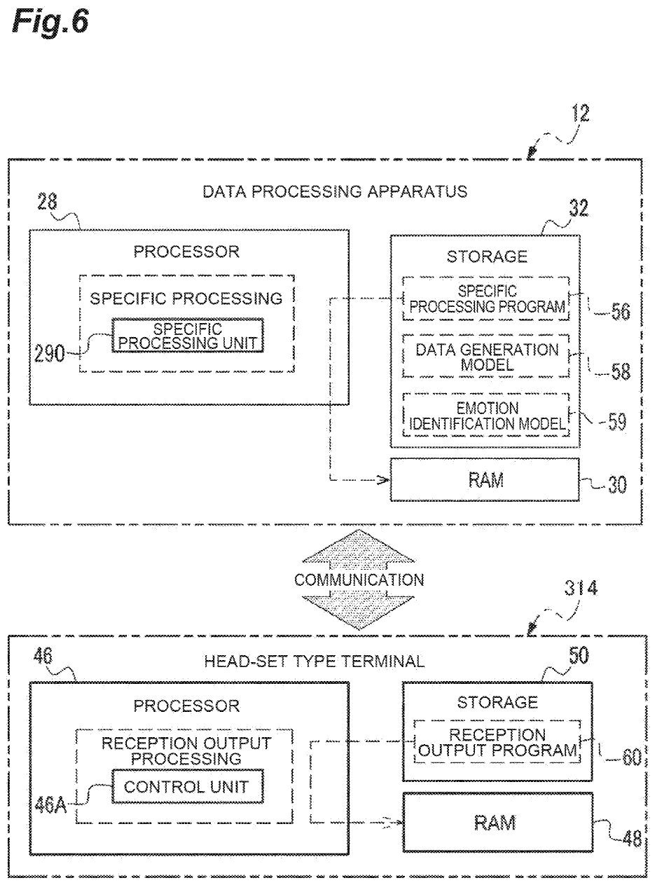

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than the generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### FOURTH EMBODIMENT

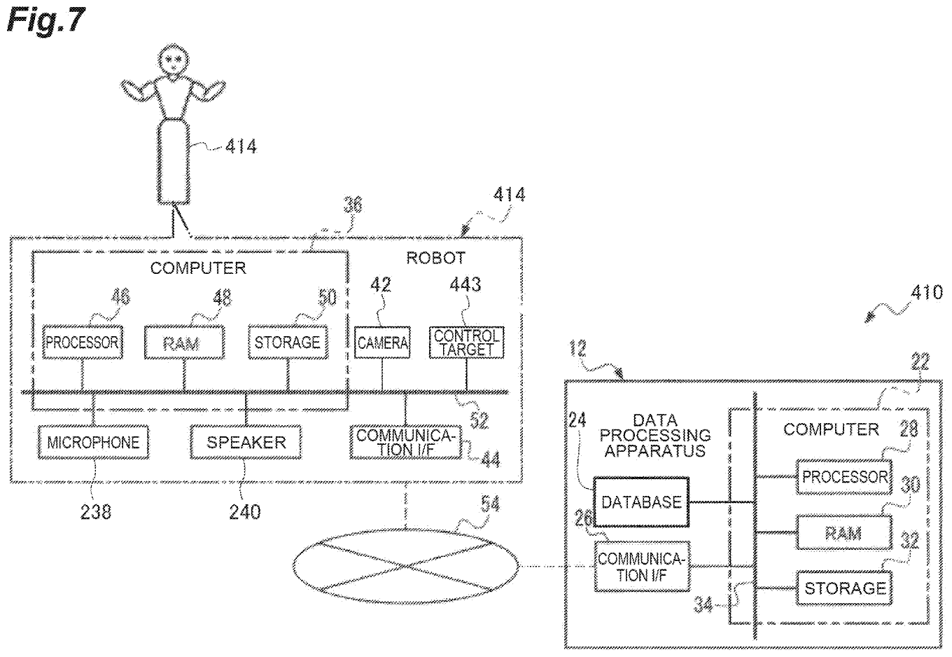

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

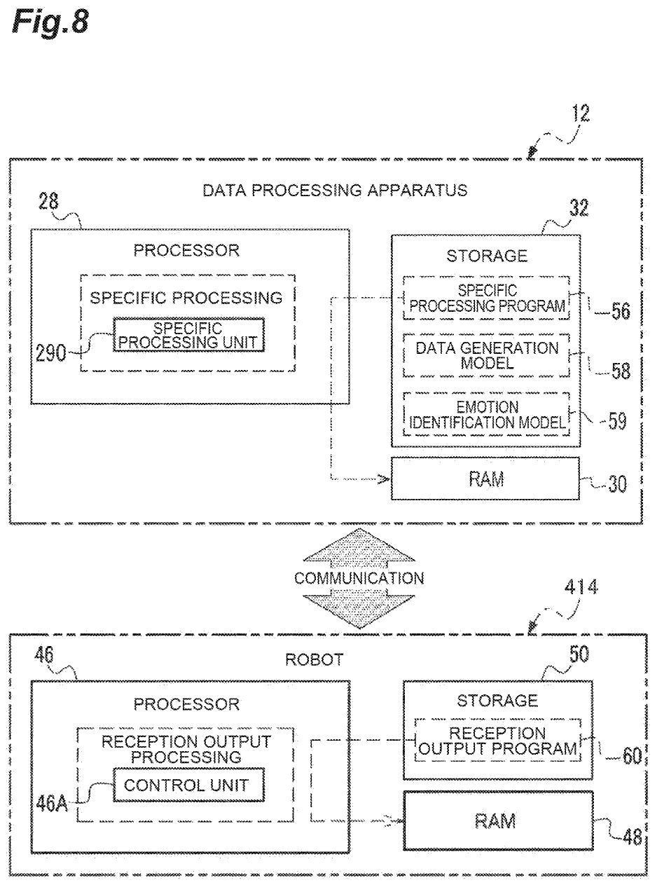

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than the generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

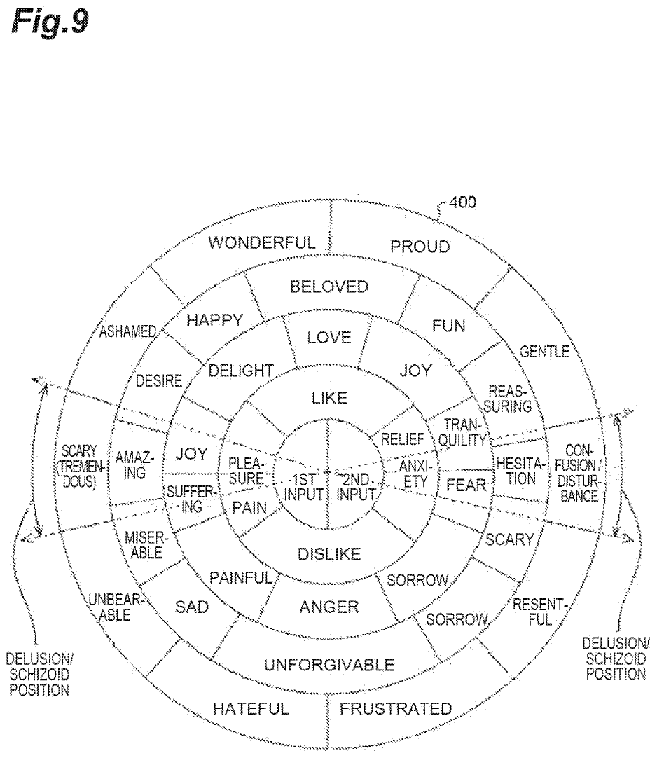

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

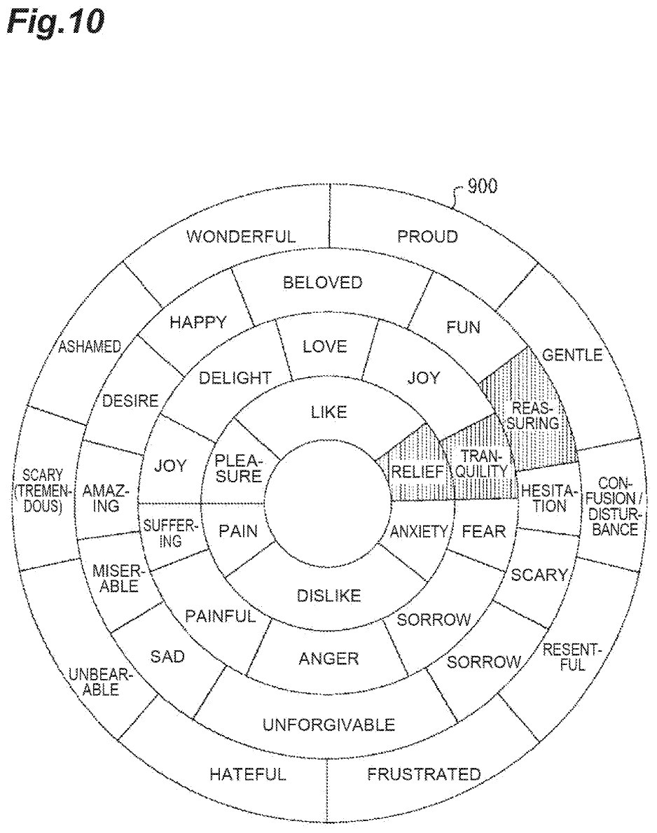

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Emotion estimation using the emotion identification model 59 can be applied to prevention of human error in operations of fishery or urban management. For example, when the system issues an emergency alert (sudden weather deterioration or power supply and demand tightness), if it is determined that an operator (user) is in a state of “panic (confusion)” or “high stress” from a facial expression or a tone of voice of the operator via the camera 42 and the microphone 238, the system may transition to an “emergency mode” in which an amount of information presentation is automatically reduced and only necessary minimum instructions (such as “course to north” or “turn off main power”) are displayed in a large size. This is specific interface control that technically controls a human cognitive load and improves safety and operability of the system.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system including: an urban data collection unit; an energy consumption prediction unit; a traffic flow control unit; an environment monitoring unit; and a resident interface unit. The urban data collection unit has a function of acquiring information from a plurality of data sources including power consumption data, traffic flow data, weather data, environmental sensor data, and resident movement pattern data, and accumulating the information in a database in real time. The energy consumption prediction unit has a function of predicting energy consumption of an entire city using a machine learning algorithm based on the collected data, and proposing peak shifting and energy-saving measures. The traffic flow control unit has a function of analyzing traffic flow data and providing an optimal route for alleviating congestion through signal control and traffic guidance. The environment monitoring unit has a function of monitoring air quality and noise levels based on environmental sensor data, and proposing improvement measures as necessary. The resident interface unit has a function of providing residents with information on energy consumption status, traffic information, and environmental information, and providing information for improving quality of life.

In some examples, the urban data collection unit collects power consumption data from an electric power company, traffic flow data from a traffic management system, weather data from a weather observation station, data on air quality and noise levels from an environmental sensor, and movement pattern data from a resident's smartphone or wearable device. This makes it possible to comprehensively grasp various environmental conditions in the city and enables real-time data updates.

In some examples, the energy consumption prediction unit analyzes past consumption patterns and current data based on the collected data, and predicts energy consumption during peak hours. This allows an electric power company to propose peak shifting and energy-saving measures and improve energy efficiency. Furthermore, the traffic flow control unit has a function of analyzing traffic flow data and providing an optimal route for alleviating traffic congestion through signal control and traffic guidance.

An example system for predicting behavior of a school of fish may include circuitry. The circuitry may be configured to: acquire marine data; estimate a movement route of the school of fish in a specific time period by predicting a behavior pattern of a target fish species using a machine learning algorithm or a statistical model based on the marine data; and display the movement route on a nautical chart of a fish finder in real time.

In some examples, the marine data may include one or more types of data including nautical chart data, GPS data, air temperature data, seawater temperature data, wind speed data, tidal current data, moon age data, tide graph data, fish catch data, fishing location data, ecological data of fish and shellfish, salinity data, or data on a rate of change in air temperature due to global warming.

In some examples, the marine data may be acquired from a weather forecast system or an ocean observation system.

In some examples, estimating the movement route includes: evaluating an influence of an ebb and flow of a tide and a phase of a moon on behavior of the target fish species using data on a moon age and a tide graph; acquiring data on a fish catch and a fishing location from records of past fishing activities; and analyzing an appearance pattern of the school of fish.

In some examples, estimating the movement route may include: simulating an influence of changes in a tidal current and a water temperature on movement of the target fish species with a numerical model; and estimating an area where the school of fish is highly likely to gather.

An example method of predicting behavior of a school of fish may include: acquiring marine data; estimating a movement route of the school of fish in a specific time period by predicting a behavior pattern of a target fish species using a machine learning algorithm or a statistical model based on the marine data; and displaying the movement route on a nautical chart of a fish finder in real time.

What is claimed is:

1. A system for predicting behavior of a school of fish, the system comprising circuitry,
wherein the circuitry is configured to:
acquire marine data;
estimate a movement route of the school of fish in a specific time period by predicting a behavior pattern of a target fish species using a machine learning algorithm or a statistical model based on the marine data; and
display the movement route on a nautical chart of a fish finder in real time.

2. The system according to claim 1, wherein the marine data includes one or more types of data including nautical chart data, GPS data, air temperature data, seawater temperature data, wind speed data, tidal current data, moon age data, tide graph data, fish catch data, fishing location data, ecological data of fish and shellfish, salinity data, or data on a rate of change in air temperature due to global warming.

3. The system according to claim 1, wherein the marine data is acquired from a weather forecast system or an ocean observation system.

4. The system according to claim 1, wherein estimating the movement route includes:
evaluating an influence of an ebb and flow of a tide and a phase of a moon on behavior of the target fish species using data on a moon age and a tide graph;
acquiring data on a fish catch and a fishing location from records of past fishing activities; and
analyzing an appearance pattern of the school of fish.

5. The system according to claim 1, wherein estimating the movement route includes:
simulating an influence of changes in a tidal current and a water temperature on movement of the target fish species with a numerical model; and
estimating an area where the school of fish is highly likely to gather.

6. A method of predicting behavior of a school of fish, the method comprising:
acquiring marine data;
estimating a movement route of the school of fish in a specific time period by predicting a behavior pattern of a target fish species using a machine learning algorithm or a statistical model based on the marine data; and
displaying the movement route on a nautical chart of a fish finder in real time.
